(19) United States
(12) Patent Application Publication
(10) Pub. No.: US 2005/0105707 A1
(43) Pub. Date: May 19, 2005

(54) Methods and apparatus for identifying and processing operator service calls

(76) Inventors: Margaret Malagon, Bergenfield, NJ (US); Susan M. Middleswarth, Silver Spring, MD (US); James Christoph Jones, Silver Spring, MD (US); Veronica Ann Cartier, Alexandria, VA (US)

Correspondence Address: VERIZON CORPORATE SERVICES GROUP INC.;C/O CHRISTIAN R. ANDERSEN, 600 HIDDEN RIDGE DRIVE, MAILCODE HQEO3H14, IRVING, TX, 75038, US

(21) Appl. No.: 10/715,661

(22) Filed: Nov. 18, 2003

(51) Int. Cl. H04M 11/00; H04M 3/42; H04M 7/00

(52) U.S. Cl. 379/207.02; 379/220.01; 379/88.18

(57) ABSTRACT

Methods and apparatus for using an operator service trigger at a telephone switch are described. A service control point is used to distinguish between non-operator service calls (0+ calls) and operator service calls (0− calls) using AIN logic at an SCP based on a trigger type identifier.

### FIELD OF THE INVENTION

The present invention is directed to methods of identifying and servicing telephone calls seeking operator assistance.

### BACKGROUND

Operator assistance is expensive to provide due to the cost of providing live operators to interact with callers. Many calls for operator assistance can be serviced through the use of automated menus providing, e.g., a caller with the opportunity to receive automated telephone account and/or billing information.

In order to reduce operator costs, it is desirable that callers seeking operator assistance first be directed to an automated menu system before involving a human operator. In this way, many operator assistance calls can be handled without human operator involvement.

A 0 is normally dialed to obtain operator assistance. A 0 plus other digits may be dialed for other purposes, e.g., to have a call billed to a particular credit card or to have call routing provided by a particular telephone service provider.

To enable telephone companies to provide advanced telephone services, many modern telephone systems are implemented as AIN networks. In such systems, particular triggers can be set at a telephone switch located at a Signal Switching Point (SSP). In response to trigger activation, processing of a call which activated a trigger is halted and a query for call processing instructions is sent to what is known as a Service Control Point (SCP). The service control point determines what call processing is to be performed based on information included in the received query and/or control logic included at the SCP. An SCP can respond to a query for call processing instructions, e.g., a TCAP message, with a CONTINUE or a Send to Outside Resource (STOR) instruction. The continue instruction causes the SSP to resume call processing based on SSP logic from the point where call processing was paused to contact the SCP. The STOR instruction can be used to cause the SSP to connect the call to an Intelligent Peripheral capable of playing a menu and collecting information, e.g., menu selections, from a caller. Thus, in the case where a call is connected to an IP, call processing may be controlled based on menu selections made by the caller.

In order to reduce the load on telephone operators, an AIN SDS trigger has been used to detect 0 or 00 calls at a telephone switch while disregarding calls beginning with a 0 but followed by other non-zero digits.

Calls placed with a single 0 are sometimes called 0− calls since they include a 0 and nothing else. Calls placed with a digit string starting with 0 followed by additional digits are sometimes called 0+ calls. 0− calls represent an operator assistance call while 0+ calls represent non-operator assistance calls. 00 calls represent calls that are destined for an inter-exchange carrier operator.

In some telephone switch implementations it has not been possible with an SDS trigger to distinguish between 0− and 00 calls. FIG. 1 illustrates the steps 102, 104, 106, 108, 110, 112, 114, 116, 118 of a known method 100. In the FIG. 1 method 100, both 0− and 00 calls are detected using the AIN SDS trigger. The SCP distinguishes between 0− and 00 calls based on the carrier type field included in the query to the SCP. 0− calls are directed to an IP which presents a caller with an automated operator assistance menu. Depending on menu selections the call may be serviced in a fully automated manner or the call may be directed to a live operator. The SCP returns a continue instruction in the case of 00 calls so that call processing will continue in a transparent manner without the call being directed to an IP for the playing of an operator services menu message.

While the use of the SDS trigger has been useful in many cases, the use of the SDS trigger in this manner has been a use which is not officially supported by telephone switch vendors and has resulted in various billing errors in some cases.

Recently, telephone switch vendors have started to support what is known as an AIN operator services trigger. With the support of the operator services trigger, some switch changes have made the continued use of the SDS trigger to identify operator service calls impractical. Most switch vendors support the capability of setting an AIN operator services trigger to distinguish between 0+ and 0− calls. Thus, with most switch vendors it is possible to set an Operator Service trigger to trigger on only 0− calls and to then have an SCP direct those calls to an IP which will provide the automated operator services menu.

Unfortunately, Nortel, a large telephone switch provider, has decided in their implementation of the operator services trigger to have the trigger activate on all calls starting with a 0, e.g., both 0− and 0+ calls. The query message sent to the SCP indicates in a trigger type identifier field whether the query was triggered by a 0+ or 0− call.

Unfortunately, the Nortel implementation of the Operator Service Trigger will result in all calls starting with a 0 producing a query to an SCP. This has the unfortunate effect of producing what, in effect, is a large number of unnecessary and undesired query's to the SCP since all 0+ calls will trigger an operator service trigger and not simply the 0− calls which are true operator service calls.

In view of the above discussion, it should be apparent that there is a need for methods and apparatus for dealing with operator service calls, preferably in an automated manner, that will not adversely effect 0+ calls or AIN network operation.

### SUMMARY OF THE INVENTION

Methods and apparatus for using an operator service trigger at a telephone switch are described. A service control point is used to distinguish between non-operator service calls (0+ calls) and operator service calls (0− calls) using AIN logic at an SCP based on a trigger type identifier.

### BRIEF DESCRIPTION OF THE FIGURES

FIG. 1 illustrates a known method.

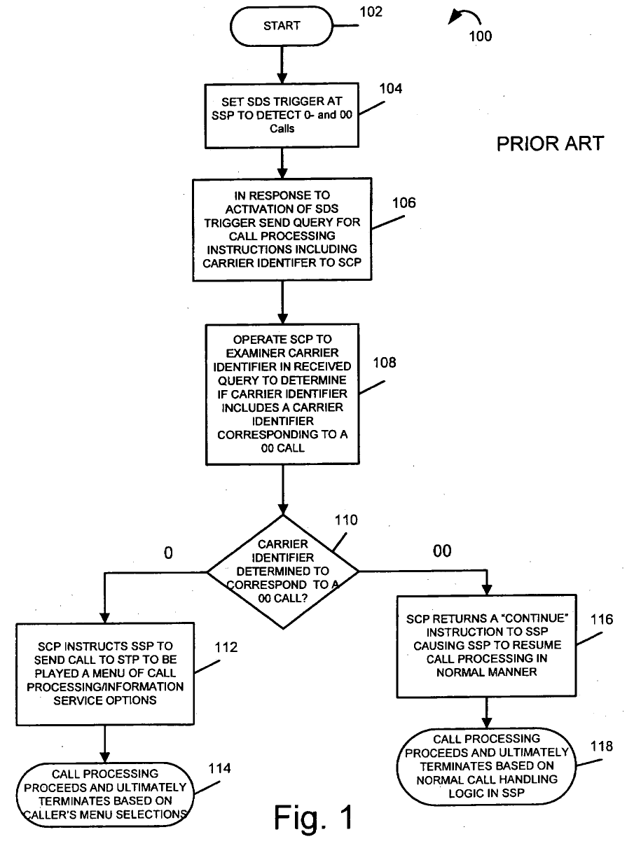

FIG. 2 illustrates the steps of a method implemented in accordance with the invention.

### DETAILED DESCRIPTION

After study of the effect of AIN network loading due to query's based on 0+ calls activating an AIN operator service trigger at Nortel switches, it was determined, at least in the case of one telephone service provider, that sufficient AIN network capacity existed to allow 0+ calls to be directed to an SCP in addition to 0− calls.

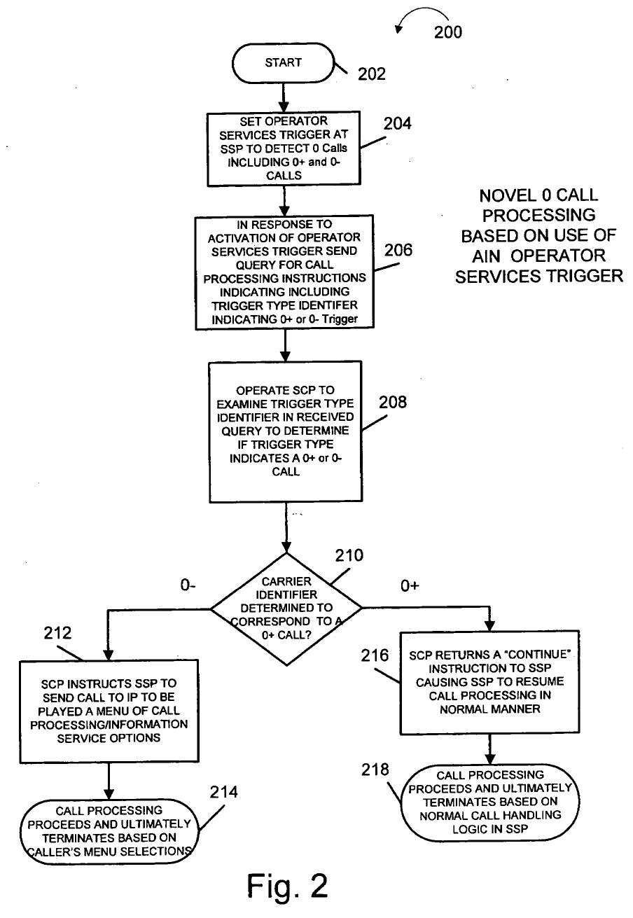

In the FIG. 2 diagram, a method 200 of handling of 0+ and 0− calls in accordance with the invention is shown. The method 200 includes steps 202, 204, 206, 208, 210, 212, 214, 216, 218. 0+ and 0− calls are detected at the SSP using an Operator Services trigger. For each call activating an operator services trigger, call processing is halted and a query for call processing instructions is sent to the SCP. The SCP analyzes the trigger type field included in the query to determine if a 0+ or 0− call activated the operator services trigger. If a 0− call activated the trigger, the SCP instructs the SSP to send the call to an IP where the caller is played an automated operator services menu. Call disposition is then controlled based on the calling party's menu selections.

If the SCP determines that a 0+ call triggered the Operator Services Trigger, a CONTINUE instruction is returned the SSP and the SSP resumes call processing. Thus, in the case of 0+ calls, the call will be processed based on SSP logic without the SCP altering the call processing outcome.

In the above described manner, the burden of distinguishing between 0+ and 0− calls is shifted from the telephone switch to the SCP. While the processing of 0+ calls at the SCP increases AIN network loading, the advantage of being able to direct 0− calls to an automated menu system can be significant justifying the AIN network loading in cases where sufficient AIN capacity exists.

1. A method of servicing telephone calls initiated using a 0, the method comprising;
detecting a call initiated using a 0 at a telephone switch using an AIN operator services trigger;
operating an SCP to distinguish based on the content of a trigger type field in a query message received from the telephone switch whether the detected call is a 0+ or a 0− call;
in the case of a 0+ call, operating said SCP to return a continue instruction to said telephone switch; and
in the case of a 0− call, operating said SCP to instruct the telephone switch to connect the call to an intelligent peripheral which plays automated operator service menus to callers.
